(19) United States
(12) Patent Application Publication
(10) Pub. No.: US 2020/0198154 A1
(43) Pub. Date: Jun. 25, 2020

(54) Method of Controlling Surface Treatment System

(71) Applicant: Taikisha Ltd., Tokyo (JP)

(72) Inventors: Hideo Shiwa, Tokyo (JP); Yasuto Teramoto, Tokyo (JP); Genji Nakayama, Tokyo (JP); Hiroyuki Suzuki, Tokyo (JP)

(21) Appl. No.: 16/615,244

(22) PCT Filed: Oct. 9, 2018
(86) PCT No.: PCT/JP2018/037571

§ 371 Date: Nov. 20, 2019

(30) Foreign Application Priority Data
Dec. 5, 2017 (JP) 2017-233713

(51) Int. Cl. B25J 15/00; B05B 13/00; B05B 15/70; B08B 3/02; B25J 11/00

(52) U.S. Cl. CPC B25J 15/0019; B05B 13/005; B24B 41/04; B08B 3/024; B25J 11/0075; B05B 15/70

(57) ABSTRACT

Provided is a system controlling method that improves versatility of a surface treatment system. In the treatment system, for treating a surface of an object by a treatment machine while moving the treatment machine relative to the surface of the object by an action of a work robot, there is provided a trackless type work machine mounting the work robot on a self-propelled cart; and the work machine mounts a robot moving device for moving the work robot relative to the self-propelled cart at least in a height direction. A work area in which the object and the work machine are present is image-captured by a position determination camera. A control device recognizes relative positional relation between the object and the self-propelled cart based on image-captured data of the position determination camera and controls the self-propelled cart based on the recognized relative positional relation, whereby the work machine is moved to a designated work position near the object.

### TECHNICAL FIELD

This invention relates to a method of controlling a surface treatment system configured to carry out various surface treatments such as a cleaning treatment, a paint coat peeling treatment, a polishing treatment, a painting treatment, etc. on a surface of e.g. an aircraft.

More particularly, the present invention relates to a method of controlling a surface treatment system, in which a treatment machine for treating a surface of the object is held by a leading end portion of a work arm of a work robot and the treatment machine is moved relative to the surface of the object by a movement of the work robot, thus treating the surface of the object by the treatment machine, wherein there is provided a trackless type work machine mounting the work robot on a self-propelled cart, the work machine mounting a robot moving device for moving the work robot relative to the self-propelled cart at least in a height direction, the self-propelled cart, the robot moving device and the work robot being controlled by a control device, respectively.

### BACKGROUND ART

Conventionally, in an aircraft surface treatment system (see FIG. 18) disclosed in Patent Document 1 identified below, a work machine 31 for treatment work includes a self-propelled cart 34 which travels along a guide wire 33 installed on a floor 32.

Further, this work machine 31 includes a rotary column 35 mounted vertically on the self-propelled cart 34 and an articulated type robot arm 36 which is elevated or lowered under a horizontal posture along the rotary column 35. And, a treatment machine 37 for treating a machine body outer face of an aircraft W is mounted to the leading end portion of this robot arm 36.

In a ceiling section inside a building structure, a rail 38 is extended in correspondence with the aircraft W accommodated therein, and a movable device 39 driven to be movable along this rail 38 and the upper end portion of the rotary column 35 are connected to each other via a utility boom 40.

This utility boom 40 is configured to allow a high-pressure cleaning water line, an electric power source, a control data line, an air line, a depressurization line, etc. from the ceiling section of the building structure to reach the work machine 31.

### BACKGROUND ART DOCUMENT

### Patent Document

Patent Document 1: Japanese Unexamined Patent Application Publication (Translation of PCT Application) No. Hei. 10-503144

### SUMMARY OF THE INVENTION

### Problem to be Solved by Invention

However, with the surface treatment system disclosed in Patent Document 1, the movement path of the work machine 31 is restricted by the guide wire 33 extended and installed on the floor and/or the rail 38 extended in the ceiling section. So, it is difficult to cope flexibly with a difference in size and/or shape of the aircraft W as a treatment subject.

Therefore, there is a problem of the versatility of the system being low as it allows treatment of only limited types of aircrafts W. Moreover, even if a certain treatment is possible when an aircraft W as a treatment subject is of a type close to the treatable type, it is difficult to move the work machine 31 to the most appropriate position for a respective part of the aircraft W as the treatment subject, so that there remains a problem of inviting reduction in the work convenience/efficiency and reduction in the treatment quality.

Moreover, as installation costs are high for the guide wire 33 and the rail 38 which need to be installed and extended over long distances on the floor or the ceiling section and the versatility of the system is low also, there arises the problem of disadvantage in terms of costs.

In view of the above-described state of the art, the principal object of the present invention is to solve the above-described problems through reasonable improvements on the method of controlling the system.

### Solution to the Problems

A first characterizing feature of the present invention relates to a method of controlling a surface treatment system, according to this characterizing feature, there is provided:

a method of controlling a surface treatment system, in which a treatment machine for treating a surface of the object is held by a leading end portion of a work arm of a work robot and the treatment machine is moved relative to the surface of the object by a movement of the work robot, thus treating the surface of the object by the treatment machine, and

in which there is provided a trackless type work machine mounting the work robot on a self-propelled cart, the work machine mounting a robot moving device for moving the work robot relative to the self-propelled cart at least in a height direction, the self-propelled cart, the robot moving device and the work robot being controlled by a control device, respectively;

wherein a work area in which the object and the work machine are present is image-captured (photographed) by a position determination camera;

wherein the control device recognizes relative positional relation between the object and the work machine, based on captured-image data of the position determination camera; and

wherein the control device causes the work machine to be moved to a designated work position near the object by controlling the self-propelled cart, based on the recognized relative positional relation.

With the controlling method having this first characterizing feature, as the control device controls the self-propelled cart based on relative positional relation recognized based on captured-image data of the position determination camera, a trackless type work machine (namely, a work machine free from the restriction imposed on its movement path by certain guide tool such as the guide wire 33 and the ceiling rail 38 disclosed in Patent Document 1) is moved to a designated work position near the object.

Therefore, irrespectively of the size and/or shape of the treatment subject, it is possible to move the work machine flexibly to the most appropriate work position for respective part of the treatment subject.

Therefore, treatment is possible with keeping the working convenience/efficiency and treatment quality high for objects of different sizes and/or shapes, so that versatility of the system can be enhanced thereby.

Moreover, no need of installing any guide wire or rail whose extension distances are large allows for significant reduction in the installation costs.

Thus, in addition to the possibility of increasing the versatility of the system, the cost-wise advantage of the system too can be increased effectively.

A second characterizing feature of the present invention specifies a preferred mode of embodying the first characterizing feature. According to this second characterizing feature:

the control device recognizes the relative positional relation, based on the captured-image data and three-dimensional shape data of the object inputted thereto.

With the controlling method having this second characterizing feature, in moving the work machine to a designated work position near the object by controlling the self-propelled cart based on the relative positional relation between the object and the work machine, the control device recognizes this relative positional relation, based on the captured-image data and three-dimensional shape data of the object inputted thereto.

Therefore, in comparison with recognition of the relative positional relation based solely on captured-image data of the position determination camera, it is possible to move the work machine to the optimal work position for respective part of the treatment subject with even higher accuracy.

A third characterizing feature of the present invention specifies a preferred mode of embodying the first or second characterizing feature. According to this third characterizing feature:

in the movement of the work machine to the designated work position, a movement distance sensor mounted on the work machine determines a distance relative to the object; and

in the movement of the work machine to the designated work position, the control device controls the self-propelled cart, based on the relative positional relation and determination information of the movement distance sensor.

With the controlling method having this third characterizing feature, as the control device controls the self-propelled cart, based on the relative positional relation between the work machine and the object recognized based on the captured-image data of the position determination camera as well as the determination information (i.e. information relating to the distance relative to the object) of the movement distance sensor mounted on the work machine, the work machine is moved to a designated work position near the object.

Therefore, in comparison with an arrangement in which the work machine is moved based solely on the relative positional relation between the work machine and the object recognized based on the captured-image data of the position determination camera, the work machine can be moved to the most appropriate work position relative to the respective part of the treatment subject with higher accuracy.

A fourth characterizing feature of the present invention specifies a preferred mode of embodying any one of the first through third characterizing features. According to this fourth characterizing feature:

the control device adjusts the self-propelled cart to the horizontal posture by controlling a tilt adjustment device mounted on the self-propelled cart based on detection information of a level sensor mounted on the work machine after moving the work machine to the designated work position.

With the controlling method having this fourth characterizing feature, the control device adjusts the self-propelled cart to the horizontal posture based on detection information of a level sensor.

Therefore, it is possible to reliably prevent the work position of the treatment machine relative to the treatment subject becoming inappropriate or the stability of the work machine being reduced, due to tilt of the self-propelled cart. With this, the workability of the surface treatment work can be further enhanced and the safety of the work can be increased also.

A fifth characterizing feature of the present invention specifies a preferred mode of embodying any one of the first through fourth characterizing features. According to this fifth characterizing feature:

as the control device controls the robot moving device based on inputted three-dimensional shape data of the object after moving the work machine to the designated work position, the work robot is moved to a position that allows surface treatment of the object by the treatment machine.

With the controlling method having this fifth characterizing feature, in moving the work robot to a position that allows surface treatment on the object by the treatment machine through an action of the robot moving device, the control device controls the robot moving device based on three-dimensional shape data of the treatment subject.

Therefore, irrespectively of the size and/or shape of the treatment subject, it is possible to move the work robot to a position that allows surface treatment on the object by the treatment machine with high accuracy.

Thus, the treatment is possible with keeping the workability and treatment quality high for objects of different sizes and/or shapes, whereby the versatility of the system can be enhanced thereby.

A sixth characterizing feature of the present invention specifies a preferred mode of embodying the fifth characterizing feature. According to this sixth characterizing feature:

a movement distance sensor configured to move together with the work robot by an operation of the robot moving device determines a distance relative to the object; and

in the movement of the work robot by the robot moving device, the control device controls the robot moving device based on the three-dimensional shape data and determination information of the movement distance sensor.

With the controlling method having this sixth characterizing feature, as the control device controls the robot moving device based on three-dimensional shape data of the object as well as determination information (i.e. information relating to the distance relative to the object) of the movement distance sensor mounted on the work machine, the work robot is moved to a position that allows surface treatment on the object by the treatment machine.

Therefore, in comparison with an arrangement in which the robot moving device is controlled based solely on the three-dimensional shape data of the object, the work robot can be moved to the position that allows surface treatment on the object by the treatment machine with higher accuracy.

A seventh characterizing feature of the present invention specifies a preferred mode of embodying any one of the first through sixth characterizing feature. According to this seventh characterizing feature:

in the surface treatment of the object by the treatment machine, the control device moves the treatment machine relative to the surface of the object by controlling the work robot based on inputted three-dimensional shape data of the object.

With the controlling method having this seventh characterizing feature, the control device moves the treatment machine relative to the surface of the object by controlling the work robot based on inputted three-dimensional shape data of the object.

Therefore, in the surface treatment of the object by the treatment machine, irrespectively of the size and/or shape of the treatment subject, it is possible to move the treatment machine appropriately relative to the surface of the treatment subject with accuracy.

Thus, the treatment is possible with keeping the workability and treatment quality high for objects of different sizes and/or shapes, so that the versatility of the system can be enhanced even more thereby.

An eighth characterizing feature of the present invention specifies a preferred mode of embodying the seventh characterizing feature. According to this eighth characterizing feature:

in the surface treatment on the object by the treatment machine, a treatment distance sensor mounted on the work arm determines a distance relative to the surface of the object; and

in the surface treatment of the object by the treatment machine, the control device moves the treatment machine relative to the surface of the object by controlling the work robot based on the three-dimensional shape data and determination information of the treatment distance sensor.

With the controlling method having this eighth characterizing feature, in moving the treatment machine by an operation of the work robot, the control device controls the work robot based on three-dimensional shape data of the object as well as determination information (i.e. information relating to the distance relative to the object) of the treatment distance sensor mounted on the work arm.

Therefore, in comparison with an arrangement in which the work robot is controlled based solely on the three-dimensional shape data of the object, in the surface treatment of the object by the treatment machine, the treatment machine can be moved relative to the surface of the treatment subject appropriately with even higher accuracy.

A ninth characterizing feature of the present invention specifies a preferred mode of embodying any one of the first through eighth characterizing features. According to this ninth characterizing feature:

in the surface treatment on the object by the treatment machine, a protruding object sensor mounted on the work arm determines presence/absence of a protruding object on the object; and

in the surface treatment of the object by the treatment machine, the control device causes the treatment machine to circumvent (detour) the protruding object by controlling the work robot based on detection information of the protruding object sensor.

With the controlling method having this ninth characterizing feature, in the surface treatment on the object by the treatment machine, the control device causes the treatment machine to circumvent (detour) the protruding object by controlling the work robot based on detection information of the protruding object sensor mounted on the work arm (i.e. information on presence/absence of protruding object).

Therefore, it is possible to reliably avoid such trouble of the treatment machine coming into contact with or colliding with the protruding object. So that, the surface treatment of the object by the treatment machine can proceed smoothly.

A tenth characterizing feature of the present invention specifies a preferred mode of embodying any one of the first through ninth characterizing features. According to this tenth characterizing feature:

in the surface treatment on the object by the treatment machine, a treatment distance sensor mounted to the work arm determines a distance relative to each one of a plurality of determination points on the surface of the object; and

in the surface treatment on the object by the treatment machine, the control device adjusts the posture of the treatment machine relative to the surface of the object by controlling the work robot based on determination information of the treatment distance sensor.

If distances to a plurality of determination points on the surface of the object are determined by a treatment distance sensor mounted to the work arm of the work robot, then, based on such determination information, it is possible to know the relative posture relation between the work arm and the object surface parts where the plurality of determination points are present in distribution.

Then, by utilizing the above, according to the controlling method having the tenth characterizing feature described above, as the control device controls the work robot based on the determination information (namely, information relating to the distances to the plurality of respective determination points) of the treatment distance sensor mounted to the leading end portion of the work arm, the posture of the treatment machine held to the leading end portion of the work arm relative to the object surface is adjusted.

Therefore, whether the surface shape of the object is e.g. a curved face or not, the surface of the object can be treated by the treatment machine, with maintaining the treatment machine under the optimal relative posture relative to the object surface, whereby high treatment quality can be obtained in a stable manner.

### BRIEF DESCRIPTION OF DRAWINGS

FIG. 1 is a perspective view showing a work state of a surface treatment work on a large aircraft,

FIG. 2 is a front view showing also a work work state of a surface treatment work on a large aircraft,

FIG. 3 is a perspective view showing a work state of a surface treatment work on a small aircraft,

FIG. 4 is a front view showing also a work state of a surface treatment work on a small aircraft,

FIG. 5 is a perspective view of a high-place work machine under a state thereof with a lift device and a feeder device thereof being contracted respectively,

FIG. 6 is a perspective view of the high-place work machine under a state thereof with the lift device and the feeder device thereof being extended respectively,

FIG. 7 is a perspective view of a low-place work machine under a state thereof with a lift device being contracted,

FIG. 8 is a perspective view of the low-place work machine under a state thereof with the lift device being extended,

FIG. 9 is a perspective view showing a condition in which a work machine is set under a standby condition,

FIG. 10 is a perspective view showing a condition in which the work machine has been moved into a work area,

FIG. 11 is a perspective view showing a condition in which the work machine has been moved to a designated work position nearby an aircraft,

FIG. 12 is a perspective view illustrating an extension/contraction movement of the lift device and the feeder device at a designated work position,

FIG. 13 is a front view illustrating an extension movement of the lift device at the designated work position,

FIG. 14 is a plan view illustrating an extension movement of the feeder device at the designated work position,

FIG. 15 is a perspective view for explaining a posture control of a treatment machine,

FIG. 16 is a perspective view for explaining a detour (bypass) control of the treatment machine,

FIG. 17 is a control block diagram, and

FIG. 18 is a front view showing a conventional aircraft surface treatment system.

### EMBODIMENTS

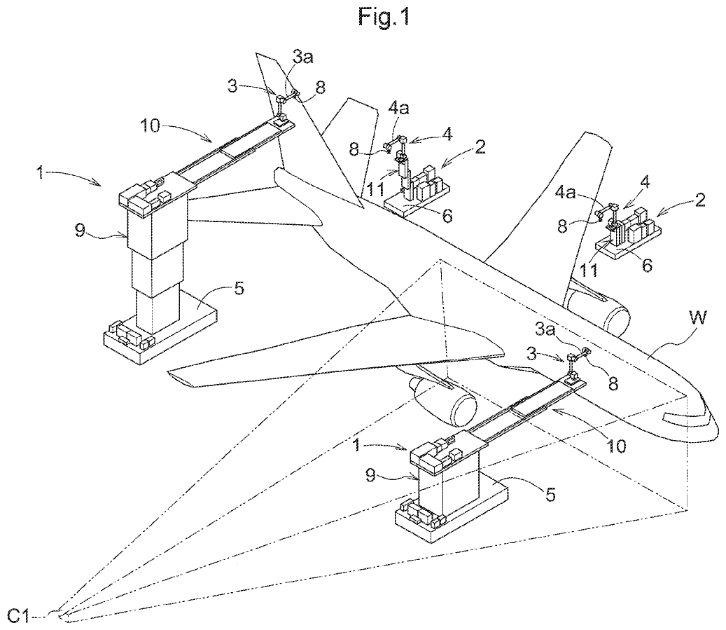

FIGS. 1-4 respectively show a situation in which a surface treatment work is being carried out on a machine body outer face of an aircraft W inside a building structure.

In this surface treatment work, on a machine body outer face of the aircraft W, various surface treatments such as a cleaning treatment, a paint coat peeling treatment, a paint surface treatment, a polishing treatment, a painting treatment, an inspection treatment, etc. are carried out one after another.

Inside a building structure accommodating the aircraft W as a “treatment subject”, there are set a high-place work machine 1 and a low-place work machine 2. Each one of these work machines 1, 2 mounts a turnable work robot 3, 4 having an articulated type work arm 3a, 4a.

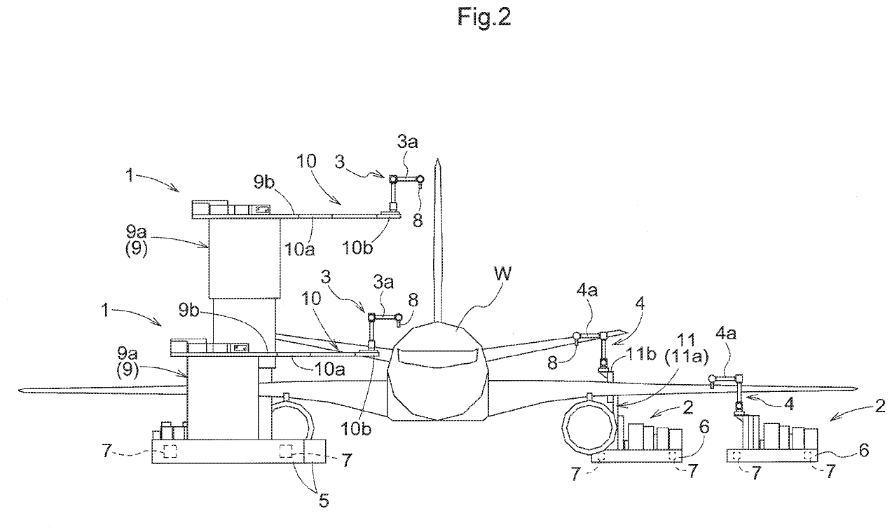

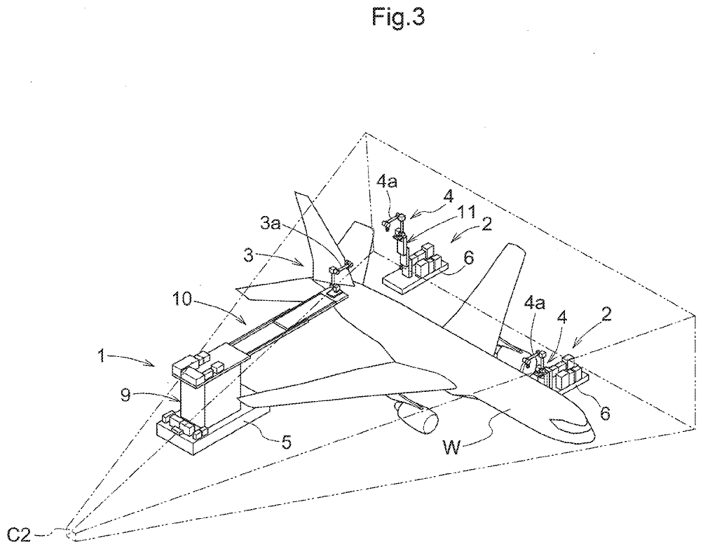

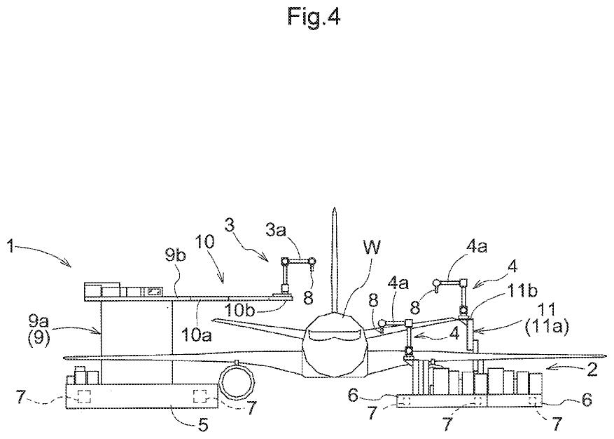

FIG. 1 and FIG. 2 show a case in which the treatment subject is a large aircraft W. FIG. 3 and FIG. 4 show a case in which the treatment subject is a relatively small aircraft W.

In both the cases, treatment works on high-place parts (e.g. a fuselage upper side, a wing upper side, a vertical tail, etc.) of the aircraft W are carried out by the high-place work machine 1. On the other hand and in parallel therewith, treatment works on low-place parts (e.g. a fuselage lower side, a wing lower side, etc.) of the aircraft W are carried out by the low-place work machine 2. Thus, the treatment works are carried out in a mode of work sharing using both the high-place work machine 1 and the low-place work machine 2 on the entire outer face of the machine body of the aircraft W.

Each work machine 1, 2 includes a trackless type electrically powered self-propelled carts 5, 6. Further, there is provided no rail or guide line that restricts the movement paths of the respective work machines 1, 2. In this sense, these respective work machines 1, 2 are “trackless” work machines.

And, the self-propelled cart 5, 6 of the respective work machine 1, 2 can travel to any desired orientation (direction) in the horizontal direction, without involving any change in the orientation of the cart body (i.e. the cart body posture as seen in the plan view).

From the above-described arrangements, each work machine 1, 2 can move speedily to a desired position on the floor inside the building structure.

Further, these self-propelled carts 5, 6 can change to any desired orientation in the horizontal direction, without involving any change in the orientation of the cart body (i.e. the cart body posture as seen in the plan view).

With the above, each work machine 1, 2 can speedily change its orientation to any orientation in the horizontal direction at each position.

The respective self-propelled cart 5, 6 mounts also a tilt adjustment device 7 for adjusting tilt of the cart body relative to the horizontal direction. By activating this tilt adjustment device 7, the tilt of the cart body relative to the horizontal direction can be adjusted in any direction in the horizontal direction.

In each work machine 1, 2, the work robot 3, 4 is mounted on the self-propelled cart 5, 6 via a robot moving device X.

Therefore, by moving the respective work machine 1, 2 to a work position near the aircraft W via traveling of the respective self-propelled cart 5, 6 and then activating the robot moving device X, it is possible to move the work robot 3, 4 to a position that allows work on a target part of the aircraft W (that is, a position that allows treatment of the target part in the machine body surface of the aircraft W by a treatment machine 8 held to the leading end portion of the work arm 3a, 4a).

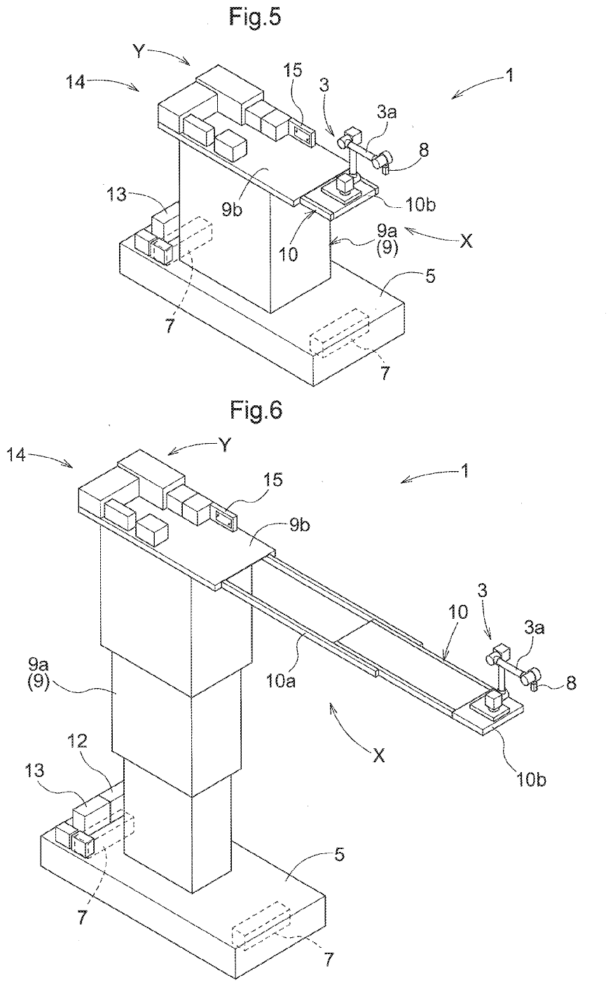

As shown in FIG. 5 and FIG. 6, the high-place work machine 1 includes, as the robot moving device X, an extension/contraction tower type lift device 9 installed on the platform of the self-propelled cart 5 and an extension/contraction arm type feeder device 10 mounted to a lift table 9b at the upper end of an extension/contraction tower section 9a of this lift device 9.

And, such work robot 3 is mounted also on a feeder table 10b provided at the leading end portion of an extension/contraction arm 10a of the feeder device 10.

The lift device 9 is capable of elevating the work robot 3 to a height (altitude) that allows a work on an upper end portion of the vertical tail of the large aircraft W by extending upwards the extension/contraction tower section 9a to its maximum extended state shown in FIG. 6.

Also, the feeder device 10 is capable of feeding the work robot 3 in the horizontal direction to a position that allows a work on lateral width-wise center portion of a fuselage upper side portion of the large aircraft W by extending the extension/contraction arm 10a to its maximum extended state shown also in FIG. 6.

Both of these lift device 9 and feeder device 10 are configured such that the extension/contraction tower section 9a or the extension/contraction arm 10a thereof is extended/contracted via a transmission mechanism such as a rack-pinion mechanism or a ball-screw mechanism by a servo motor.

Therefore, by adjusting the extension amount of the extension/contraction tower section 9a or the extension/contraction arm 10a by an operation of the servo motor, the position of the respective work robot 3 relative to the aircraft W can be adjusted in accordance with the particular body shape of the aircraft W.

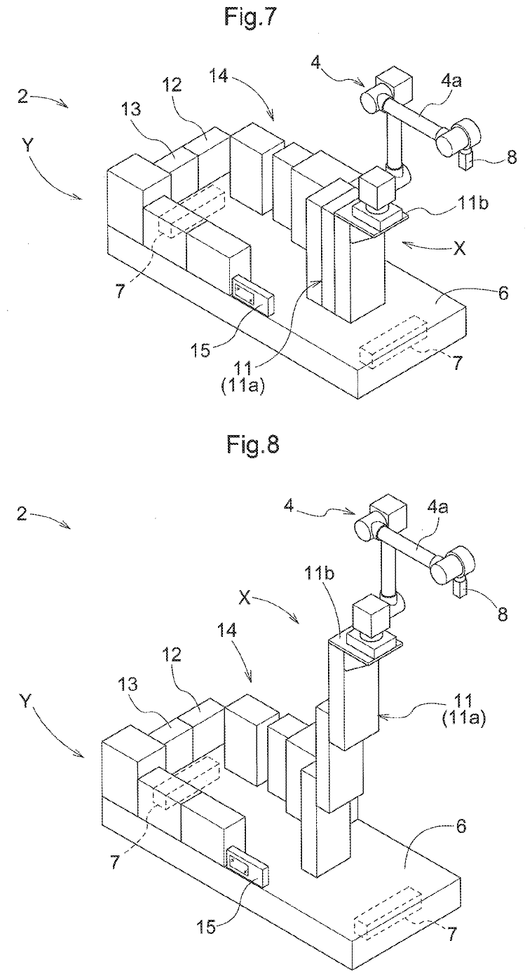

As shown in FIG. 7 and FIG. 8, the low-place work machine 2 includes, as its robot moving device X, an extension/contraction boom type lift device 11 mounted on the self-propelled cart 6.

And, the work robot 4 is mounted on a lift table 11b provided at the leading end portion of the extension/contraction boom 11a of the lift device 11.

This lift device 11 too is configured such that the extension/contraction boom 11a thereof is extended/contracted via a transmission mechanism such as a rack-pinion mechanism or a ball-screw mechanism by a servo motor.

Therefore, by adjusting the extension amount of the extension/contraction boom 11a by an operation of the servo motor, the position of the work robot 4 relative to the aircraft W can be adjusted in accordance with the particular body shape of the aircraft W.

Incidentally, the transmission mechanism of the respective lift device 9, 11 and the feeder device 10 is not limited to a rack-pinion mechanism or a ball-screw mechanism, but other various types of transmission mechanism can be employed.

Each self-propelled cart 5, 6 includes a power source connection section 12 and mounts a battery 13.

And, the self-propelled carts 5, 6 and the various electric devices mounted on these self-propelled carts 5, 6 such as the work robots 3, 4, the lift devices 9, 11, the feeder device 10, etc. can be operated by either electric power supplied from a power line connected to the power source connection section 12 or electric power supplied from the battery 13.

The treatment machines 8 to be held to the leading end portions (namely, the “wrist” portions) of the work arms 3a, 4b of the work robots 3, 5 can be changed in accordance with a type of the surface treatment to be carried out.

A plurality of kinds of such treatment machines 8 for replacement (e.g. a drug applicator, a cleaning water applicator, a putty polisher, a painting machine, etc.) are set under a condition that allows automatic change (replacement) through a cooperative action between the work robot 3, 4 and a treatment machine changer device, and these treatment machines are stored and accommodated as such in a treatment machine accommodation section 14 of each work machine 1, 2.

Further, each work machine 1, 2 mounts also various kinds of supply source devices Y such as a compressor for feeding compressed air to the treatment machine held by the work robot 3, 4 in a treatment work using the compressed air or a tank and a pump for feeding paint and curing liquid to the treatment machine 8 (painting machine) held by the work robot 3, 4 in a painting treatment.

Incidentally, as for the various kinds of electric devices to be mounted on the respective work machines 1, 2, these devices are provided with explosion-proof feature for reliably preventing e.g. fire-catching trouble at the time of e.g. painting treatment.

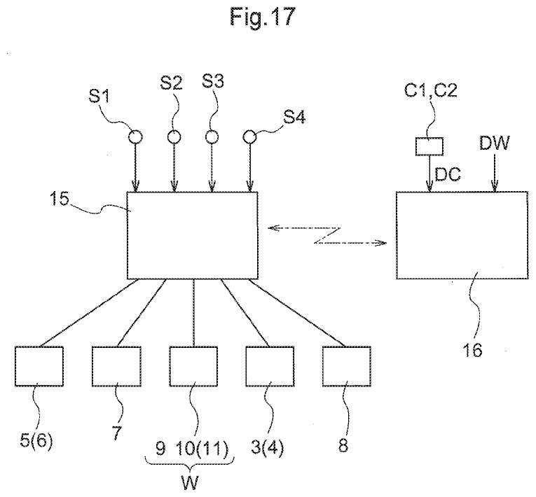

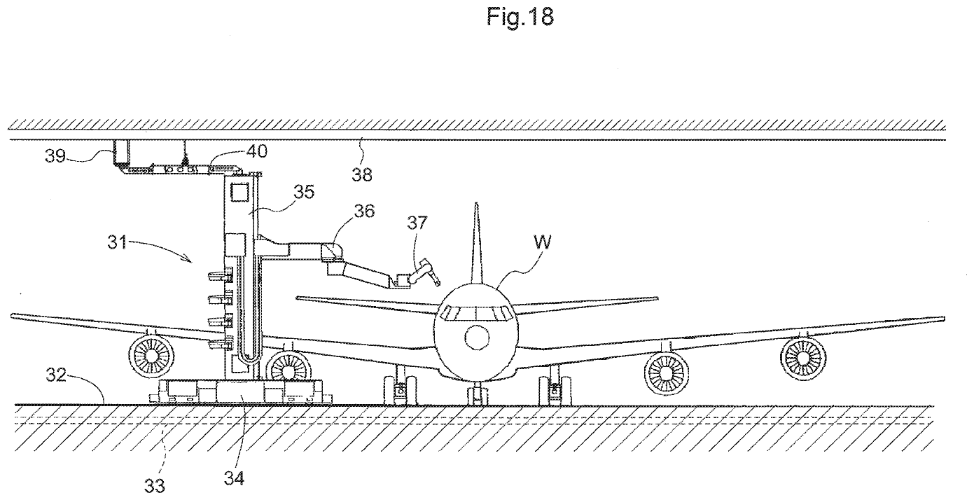

On the other hand, in the respective work machines 1, 2 (see FIG. 17), laser type movement distance sensors S1 for determining a distance relative to a nearby object are mounted at respective parts (e.g. the four corner portions of the self-propelled cart 5, 6, the feeder table 10b of the feeder device 10, the lift table 11b of the extension/contraction boom lift device 11, etc.) of the work machine 1, 2.

Further, the respective work machine 1, 2 mounts also a level (horizontal level) sensor S2 for determining a level (horizontal level) of the self-propelled cart 5, 6.

Moreover, the work arm 3a, 4a of the work robot 3, 4 of the respective work machine 1, 2 mounts also a laser type treatment distance sensor S3 for determining a distance relative to a machine outer face of the aircraft W, a laser type protruding object sensor S4 for detecting any protruding object present on the machine outer face of the aircraft W, and so on.

And, each work machine 1, 2 mounts an onboard controller 15. This onboard controller 15 controls the self-propelled cart 5, 6 and the various mounted devices such as the work robot 3, 4, etc.

On the other hand, in the building structure accommodating the aircraft W as the treatment subject, a plurality of position determination cameras C1, C2 for image-capturing the surrounding area of the accommodated aircraft W are installed at respective parts in distribution and a general controller 16 is also provided.

The onboard controllers 15 mounted on the respective work machines 1, 2 and the general controller 16 installed inside the building structure are control devices responsible for controlling of the surface treatment system having both the work machines 1, 2.

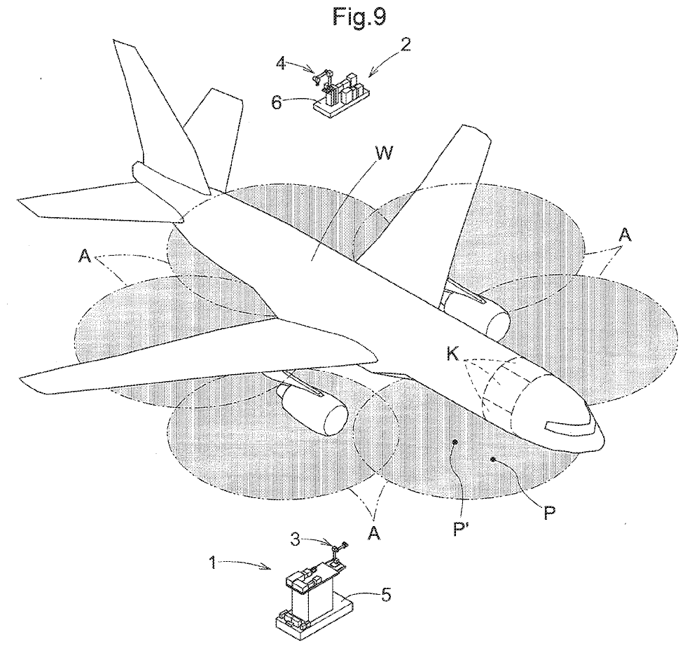

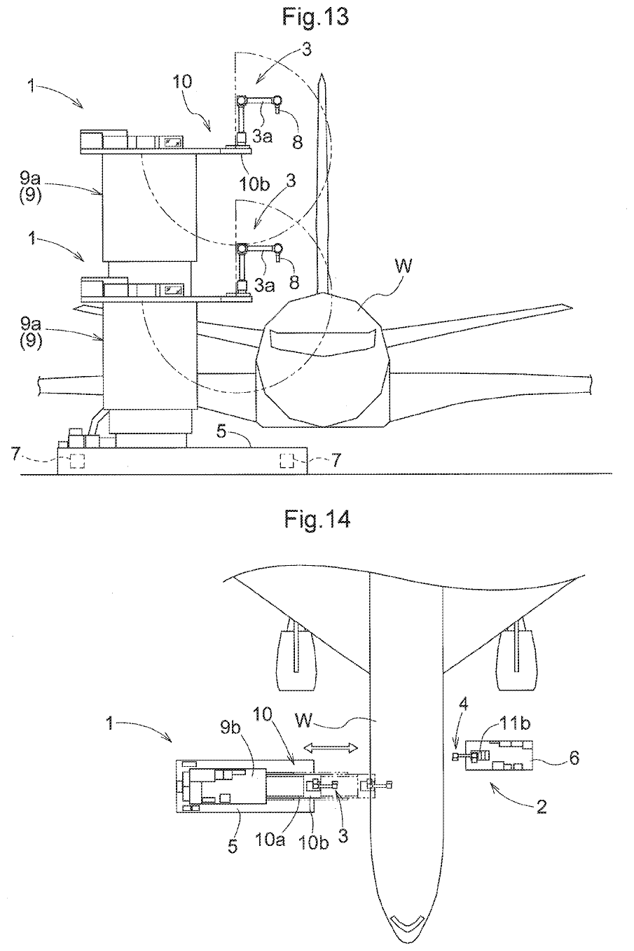

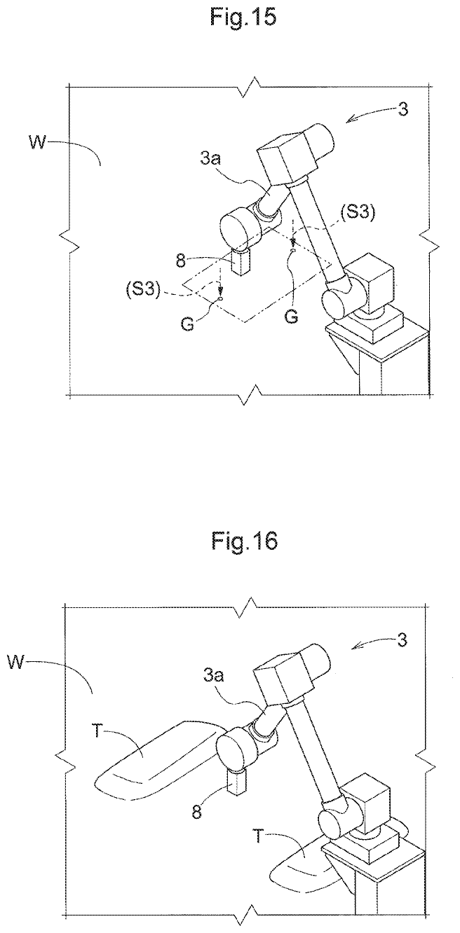

Next, a mode of work of a surface treatment work carried out by using these high-place work machine 1 and low-place work machine 2 will be explained with reference to FIGS. 9 through 17. As this work mode is same for both the work machines 1, 2, here, explanation will be made mainly for the high-place work machine 1 as representing the mode.

<First Step>

As shown in FIG. 9, a plurality of work areas A are set in advance around the aircraft W accommodated inside the building structure. Here, each work area A has a size corresponding to a range whose image can be captured by the position determination cameras C1.

Further, on the machine outer face of the accommodated aircraft W, there are set a plurality of treatment sections K arranged in a matrix for dividing this machine outer face into a plurality of sections.

Incidentally, the setting of these treatment sections K may be made automatically by the general controller 16, based on three-dimensional shape data Dw of the aircraft W obtainable from e.g. a designing document of the aircraft W.

### <Second Step>

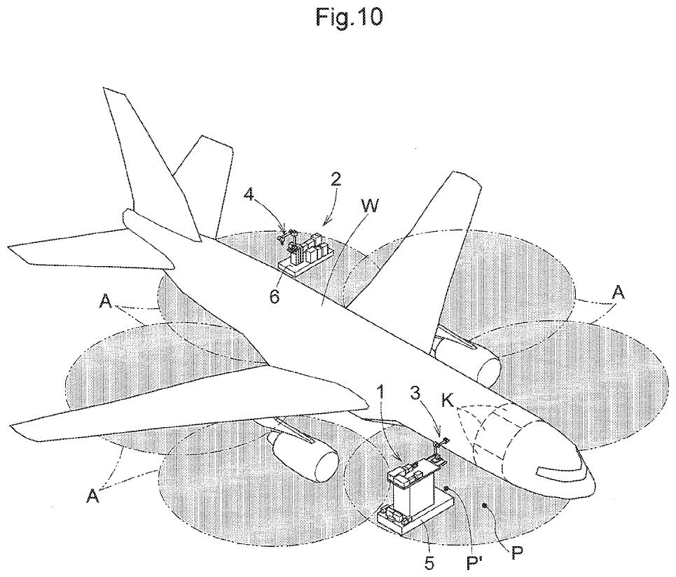

As shown in FIGS. 9 and 10, by a manual operation on the general controller 16 or the onboard controller15, the work machine 1 is moved into a certain work area A from its standby position outside the work area A.

In this movement operation, the manual operation on the general controller 16 or the onboard controller 15 can be a remote manual operation using a remote controller or a direct manual operation on the general controller 16 or the onboard controller 15.

Further, in this movement into the work area A, the self-propelled cart 5 of the work machine 1 is caused to travel by electric power supplied from the battery 13, without using the power source connection section 12.

After the work machine 1 is moved into the work area A, in order to secure further electric power for a (utility) work subsequent thereto, a power line extend from a nearby power supply section will be connected to the power supply connection section 12 of the work machine 1.

<Third Step>

After this power connection, based on the three-dimensional shape data Dw of the aircraft W inputted in advance to the general controller 16 and captured-image data Dc transmitted wirelessly from the position determination camera C1 set at a predetermined position (i.e. the captured-image data of the work area A where a portion of the aircraft W and the work machine 1 are present), the relative positional relation between the work machine 1 and the aircraft W is caused to be recognized by the general controller 16.

And, based on this recognized relative position relation between the work machine 1 and the aircraft W, a movement instruction for moving the work machine 1 to a designated work position P nearby the aircraft W is transmitted wirelessly from the general controller 16 to the onboard controller 15 of the work machine 1.

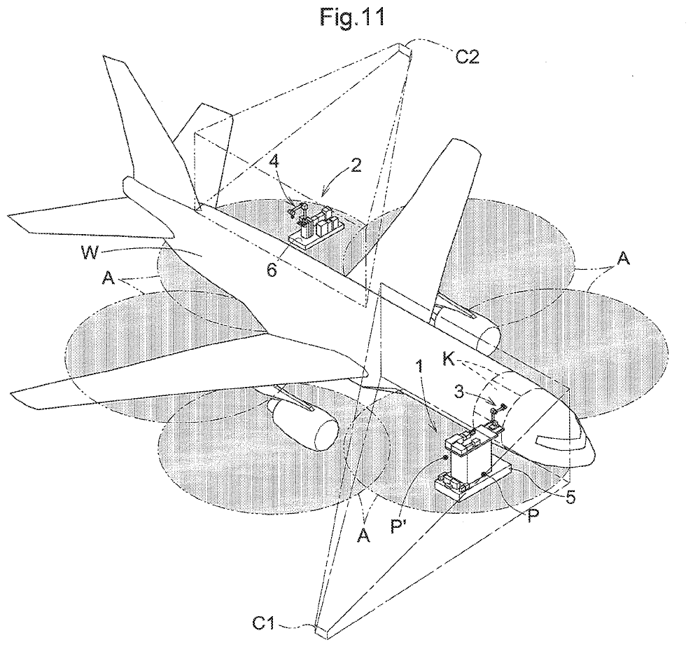

Upon receipt of this movement instruction, the onboard controller 15 of the work machine 1 controls the self-propelled cart 5, whereby the work machine 1 is moved automatically to the designated work position P nearby the aircraft W as illustrated in FIGS. 10-11. Further, in association therewith, the orientation of the work machine 1 is also adjusted automatically to a work orientation in direct opposition to the aircraft W.

In this automatic movement to the designated work position P, the onboard controller 15 monitors the distance between the work machine 1 and the aircraft W continuously and in parallel therewith.

And, as the onboard controller 15, via this monitoring, adds correction in the control of the self-propelled cart 5 based on the three-dimensional shape data Dw of the aircraft W and the captured-image data Dc of the position determination camera C1, the work vehicle 1 will be stopped at the designated work position P precisely.

Moreover, the onboard controller 15 monitors also presence/absence of any obstacle which may be present in the surrounding of the work machine 1 based on the determination information provided by the movement distance sensor S1 mounted on the work machine 1.

By this monitoring, the onboard controller 15 will stop the self-propelled cart 5 in case presence of an obstacle has been detected, thus avoiding collision with this obstacle and also will issue an alarm for reporting the presence of the obstacle.

Further, after stopping the work machine 1 at the designated work position P, the onboard controller 15 will control the tilt adjustment device 7 based on detection information of the level sensor S2, thus adjusting the self-propelled cart 5 to a substantially perfectly horizontal posture.

<Fourth Step>

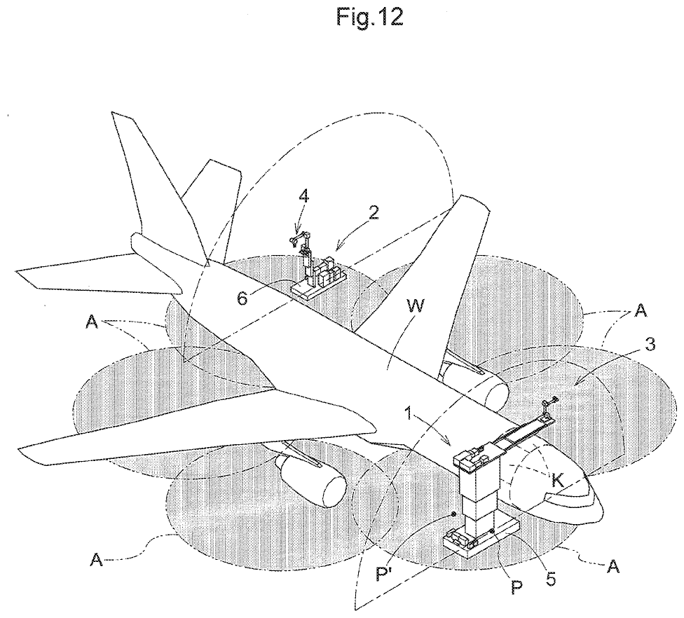

After the above-described adjustment of the (horizontal) level of the self-propelled cart 5, the onboard controller 15, based on the three-dimensional shape data Dw of the aircraft W transmitted from the general controller 16 and the distance information relative to the machine body of the aircraft W obtained by the movement distance sensor S1 mounted on the feeder table10, as illustrated in FIGS. 12-14, will elevate the work robot 3 to a required height (altitude) by extending the lift tower section 9a of the lift device 9 and also will subsequently extend the extension/contraction arm 10a of the feeder device 10 to move the work robot 3 closer to the machine body outer face of the aircraft W.

Namely, by these operations of the lift device 9 and the feeder device 10, the work robot 3 of the work machine 1 is caused to be moved close to one of the treatment sections K set in the machine body outer face of the aircraft W.

<Fifth Step>

Thereafter, based on the three-dimensional shape data Dw of the aircraft W and the distance information relative to the machine body of the aircraft W obtained by the movement distance sensor S3 mounted to the work arm 3a of the work robot 3, the onboard controller 15 will control arm movements of the work robot 3, thereby to move the treatment machine 8 held to the work arm 3a along the machine body outer face of the aircraft W while providing a treating action on this machine body outer face of the aircraft W. With this, one treatment section K in the machine body outer face of the aircraft W is treated.

Also, in the above-described movement of the treatment machine 8 by the robot movements, the onboard controller 15 will determine a distance between the sensor S3 and a determination point G for a plurality of such determination points G on the machine body outer face around the treatment machine 8.

Further, based on the result of this determination, the onboard controller 15 will calculate tilt of the machine body outer face part to be treated by the treatment machine 8.

And, the onboard controller 15 will add a correction to posture control of the treatment machine 8 based on the three-dimensional shape data Dw of the aircraft W, based on the result of the above-described calculation, whereby the treatment machine 8 will be caused to provide its treatment action with constantly keeping its vertical posture relative to each treatment part of the machine body outer face.

Moreover, in the course of the movement of the treatment machine 8 by the robot movements, as illustrated in FIG. 16, the onboard controller 15 provides a further function of controlling the work robot 3 in such a manner as to move the treatment machine 8 with circumventing (detouring) a protruding object T if such protruding object T of the aircraft W is detected by the protruding object sensor S4 mounted to the work arm 3a.

<Sixth Step>

Upon completion of the treatment on the one treatment section K in the machine body outer face of the aircraft W at the fifth step described above, the onboard controller 15 will again operate the lift device 9 and the feeder device 10 based on the three-dimensional shape data Dw of the aircraft W and the distance information relative to the machine body of the aircraft W obtained by the movement distance sensor S1 mounted to the feeder table 10, whereby the work robot 3 will be caused to move closer to a next treatment section K in the machine body outer face of the aircraft W.

And, by implementing the above-described fifth step again on this next treatment section K, this next one treatment section K in the machine body outer face of the aircraft W is treated.

<Seventh Step>

With repetition of these fifth and sixth steps, a treatment work on each treatment section K with locating the work machine 1 at one designated step position P is completed. Then, the onboard controller 15 will contract the extension/contraction tower section 9a of the lift device 9 and the extension/contraction arm 10a of the feeder device 10, thereby to return the work robot 3 to its storage position in the work machine 1.

Thereafter, the general controller 16, based on the recognized relative position relation between the work machine 1 and the aircraft W, will transmit to the onboard controller 15 a movement instruction for moving the work machine 1 to a next designated work position P′ near the aircraft W within the same work area A.

In response to this movement instruction, the onboard controller 15 will move the work machine 1 to the next designated work position P′ in the same manner as the third step described above.

Further, at this designated work position P′, the onboard controller 15 controls the tilt adjustment device 7 again, based on detection information of the level sensor S2, thus adjusting the the self-propelled cart 5 to the horizontal posture again.

Thereafter, with repletion of the fourth through seventh steps, treatment works on one work area A are completed.

And, upon completion of the treatment works in one work area A, for each one of the remaining work areas A, the treatment works will be carried out similarly in the order of from the first to seventh step, whereby one kind of treatment work among a plurality of kinds of surface treatment works is carried out and after its completion, after changing the treatment machine 8 to be held to the work arm 3a of the work robot 3, the surface treatment work on the machine body outer face of the aircraft W will be carried out for the respective work area A similarly.

In the above-described series of surface treatment works for the machine body outer face of the aircraft W, the low-place work machine 2 will implement controls similarly to the high-place work machine 1, except for the control for the feeder device 10.

Incidentally, the high-place work machine 1 and the low-place work machine 2 are used basically as a pair, and will be controlled as such in such a manner to avoid mutual interference between work areas thereof, by e.g. disposing them at positions opposite to each other across the treatment subject W therebetween.

### INDUSTRIAL APPLICABILITY

The present invention is applicable to a surface treatment of various kinds of objects, not limited to an aircraft, but including a railway car, a boat, a rocket, a bridge, a housing, etc.

### DESCRIPTION OF SIGNS

W: aircraft (treatment subject)
8: treatment machine
3, 4: work robot
3a, 4a: work arm
5, 6: self-propelled cart
1, 2: trackless type work machine
X: robot moving device (lift device, feeder device)
15: onboard controller (control device)
16: general controller (control device)
A: work area
C1, C2: position determination camera
Dc: captured-image data
P, P′: designated work position
Dw: three-dimensional shape data
S1: movement distance sensor
S2: level sensor
7: tilt adjustment device
S3: treatment distance sensor
S4: protruding object sensor
T: protruding object
K: treatment section
G: determination point

1. A method of controlling a surface treatment system, the method comprising:
moving a treatment machine for treating a surface of an object relative to the surface of the object by a movement of a work robot, the treatment machine being held by a leading end portion of a work arm of the work robot, thus treating the surface of the object by the treatment machine,
wherein the surface treatment system comprises trackless type work machine mounting the work robot on a self-propelled cart, the work machine mounting a robot moving device for moving the work robot relative to the self-propelled cart at least in a height direction, and the self-propelled cart, the robot moving device, and the work robot being controlled by a control device, respectively;
image-capturing, by a position determination camera, a work area in which the object and the work machine are present;
recognizing, by the control device, a relative positional relation between the object and the work machine, based on captured-image data of the position determination camera and three-dimensional shape data of the object inputted to the control device; and
moving, by the control device controlling the self-propelled cart, the work machine to a designated work position near the object, based on the recognized relative positional relation.

2. (canceled)

3. The method of controlling a surface treatment system of claim 1, wherein:
moving the work machine to the designated work position comprises:
determining, by a movement distance sensor mounted on the work machine, a distance relative to the object; and
controlling, by the control device, the self-propelled cart based on the relative positional relation and the distance relative to the object determined by the movement distance sensor.

4. The method of controlling a surface treatment system of claim 1, the method further comprising adjusting, by the control device, the self-propelled cart to a horizontal posture by controlling a tilt adjustment device mounted on the self-propelled cart based on detection information of a level sensor mounted on the work machine after moving the work machine to the designated work position.

5. The method of controlling a surface treatment system of claim 1, wherein as the control device controls the robot moving device based on the three-dimensional shape data of the object after moving the work machine to the designated work position, the work robot is moved to a position that allows surface treatment of the object by the treatment machine.

6. The method of controlling a surface treatment system of claim 5, the method further comprising:
determining, by a movement distance sensor configured to move together with the work robot by an operation of the robot moving device, a distance relative to the object; and
controlling, by the control device, the robot moving device to move the work robot based on the three-dimensional shape data and the distance relative to the object determined by the movement distance sensor.

7. The method of controlling a surface treatment system of claim 1, wherein moving the treatment machine for treating the surface of the object comprises controlling, by the control device, the work robot to move the treatment machine relative to the surface of the object based on the three-dimensional shape data of the object.

8. The method of controlling a surface treatment system of claim 7, further comprising, in surface treatment of the object by the treatment machine:
determining, by a treatment distance sensor mounted on the work arm, a distance relative to the surface of the object; and
controlling by the control device, the work robot to move the treatment machine relative to the surface of the object based on the three-dimensional shape data and of the distance relative to the surface of the object determined by the treatment distance sensor.

9. The method of controlling a surface treatment system of claim 1, further comprising, in surface treatment of the object by the treatment machine:
determining, by a protruding object sensor mounted on the work arm, a presence of a protruding object on the object; and
controlling, by the control device, the work robot to cause the treatment machine to circumvent the protruding object based on of the presence of the protruding object determine by the protruding object sensor.

10. The method of controlling a surface treatment system of claim 1, further comprising, in surface treatment on the object by the treatment machine:
determining, by a treatment distance sensor mounted to the work arm, a distance relative to each one of a plurality of determination points on the surface of the object; and
controlling, by the control device, the work robot to adjust a posture of the treatment machine relative to the surface of the object based on the distance relative to each one of the plurality of determination points determined by the treatment distance sensor.
